(19) United States
(12) Patent Application Publication
(10) Pub. No.: US 2012/0227597 A1
(43) Pub. Date: Sep. 13, 2012

(54) STENCIL PRINTING FRAME

(75) Inventors: Tom Clara Louis Meeus, Retie (BE); Paul Wilem Godijn, Huizen (NL); Ravindra Mohan Bhatkal, East Brunswick, NJ (US)

(73) Assignee: ALPHA FRY LIMITED, Surrey (GB)

(21) Appl. No.: 13/391,737

(22) PCT Filed: Aug. 27, 2010
(86) PCT No.: PCT/GB10/01627

§ 371 Date: Jun. 4, 2012

Related U.S. Application Data
(60) Provisional application No. 61/237,538, filed on Aug. 27, 2009.

(51) Int. Cl. B05C 17/08; B41C 1/14

(52) U.S. Cl. 101/126; 101/128.4

(57) ABSTRACT

The present invention provides a stencil printing frame comprising a border member (5) and a foil sheet (65) attached thereto, wherein the border member (5) is formed as a single piece having sides and corners that define the frame, the single piece having two ends interlocked to form a joint on one corner or side, and wherein at least one corner comprises abutting faces arranged to prevent relative movement of the faces. The invention further provides a method for forming the frame and for uses of the frame once formed.

The present invention relates generally to the field of printing systems that use stencils and more particularly to a frame for retaining a foil stencil and a method for producing it.

Stencils are used in a number of printing processes, all of which generally involve the targeted deposition of a material onto a substrate. Stencils have been used, for example, to print solar cells and fuel cells or components thereof.

A common use of stencils is for the mounting of electronic surface mount devices (SMDs) on printed circuit boards (PCBs). The stencil is used to deposit solder paste on the PCB's device interconnection points. The board is warmed to cause the solder to soften or “reflow” and the external interconnection features (such as leads, bumps, or balls) of the SMDs placed on the solder are thus held in place.

The solder paste is commonly applied to the PCB by a printing process using a squeegee to physically deposit and distribute the solder paste evenly across the stencil. The solder paste passes through the stencil apertures and is deposited on designated areas on the PCB. The stencil is then lifted, leaving behind the intended solder paste pattern on the PCB.

EP0643902 discloses an apparatus for enabling solder paste to be applied to a circuit board by a stencilling process. The apparatus comprises a stencil of sheet metal attached to a support having at least two flexible sides. The stencil sheet has sharp edges which can cause user injuries when the sheet is attached to the support.

When stencils are used in other printing techniques, such as forming solar cells, a squeegee or similar technique may also be used. One alternative printing technique is direct printing using a nozzle, optionally sealed against the stencil, which injects a desired amount of material directly through one or more of the holes in the stencil.

In order to ensure accurate printing the foil stencil is often held under tension over the substrate. The foil stencil is usually held in a frame which is accurately registered over the substrate by a tensioning machine. Known techniques for holding the foil under tension include gluing the foil to a sheet of material held in a preformed frame. Thus the foil adopts the tension of the material. However, the frame takes up a considerable amount of storage space. Other techniques include etching retaining holes in the foil sheet so that it can be fitted directly into a tensioning machine. However, since the foil stencil is commonly stored without tension, the foil is prone to damage.

US2008/0216681A discloses the use of a frame unit for holding a screen printing foil. The frame has separate corner pieces which are designed to allow expansion of the frame and, hence, tensioning of the foil, when placed in a tensioning device.

There is, therefore, a desire for an improved stencil printing frame to at least mitigate some, or all, of the problems associated with the prior art, or to provide a commercially viable alternative thereto.

According to a first aspect, the present invention provides a stencil printing frame comprising a border member and a foil sheet attached thereto, wherein the border member is formed as a single piece having sides and corners that define the frame, the single piece having two ends interlocked to form a joint on one corner or side, and wherein at least one corner comprises abutting faces arranged to prevent relative movement of the faces. By the term “prevent”, as used throughout this specification, it is meant that on application of a reasonable force, movement is at least resisted and preferably the arrangement substantially prohibits any movement caused by the reasonable force. A reasonable force includes those forces experienced by a stencil printing frame in use.

The present invention will now be further in the following passages and different aspects/embodiments of the invention are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

A stencil printing frame is a frame for retaining and/or supporting a stencil and is suitable for use in any printing technique that relies upon a stencil for printing. A preferred embodiment is a solder-printing stencil-frame which is used for solder printing suitable for attaching SMDs to a PCB. The stencil printing frame according to the first aspect is provided in combination with a foil sheet.

Printing includes any technique of deposition of a material onto a substrate. It would be appreciated by a person skilled in the art that the stencil could equally be used as a mask to allow selective exposure of a substrate to radiation. Such photo-lithographic printing processes can rely on any electromagnetic radiation, such as UV, infra-red, visible or microwave radiation. Photo-lithographic techniques are well known.

The abutting faces can prevent (or resist, as discussed above) the relative movement (such as rotation or translation) of the faces in at least one direction. The faces abut to provide a minimum internal angle of the corner and thus prevent over-compression of the corner angles. Preferably the faces also resist twisting of the corner piece by friction. Furthermore, the faces preferably resist opening of the corner angle, sliding of one corner piece past the other, or shearing of the corner pieces past each other. Thus the faces can prevent the distortion of the corner angles. In an embodiment having four equal corner angles the use of corners having abutting faces can prevent any distortion of the frame.

While a single corner piece comprising abutting faces can be arranged to prevent the relative movement of the faces, it is preferred that each corner comprises abutting faces arranged to prevent relative movement of the faces. This serves to increase the structural rigidity of the frame which makes it less likely to be damaged in storage or use.

It is preferred that the abutting faces have non-planar complementary profiles. That is, the surfaces of the abutting faces when abutting do not merely lie in the plane extending from the interior edge of the corner to the exterior vertex of the corner but are each formed with convex or concave features which cooperate with corresponding concave or convex features on the face against which they abut. The abutting faces preferably, but not necessarily, contact each other with substantially all of their surface area. It has been found that the use of non-planar surfaces helps to prevent sliding of the faces past each other and thus minimises the stresses exerted on the continuous strip of material running through the corner.

It is particularly preferred that the abutting faces have interconnectable profiles. This means that the faces when formed into a frame resist the increasing of the corner angle or the opening of the frame. The interconnecting profiles may be interconnected by any method. A preferred method of interconnecting the profiles comprises twisting the frame so that the features of one face are arranged over the features of the other face then allowing the frame to relax so that the interconnectable features interconnect. In other embodiments the features of one face may be sufficiently compressible to allow interconnection of the faces but sufficiently resilient to resist separation. In further embodiments hooks, rivets, bolts, latches or other such features may be used in addition, or alone, to interconnect the faces.

It is preferred that the border member is formed of a light, cheap and resilient material. It is particularly preferred that the border member is made of an extrudable material suitable for machining. Such materials are known in the art. Preferably the frame is made of aluminium or alloys thereof.

The stencil printing frame of the present invention may be of any polygonal shape. The use of a shape having straight sides allows for the formation of the frame from a simple extruded linear border member. Thus the frame can be, for example, triangular, rectangular, pentagonal etc. It is preferred that the frame is rectangular, in particular square, since this is the most convenient shape for preparation and, since most PCBs (for example) or device substrates are rectangular, this minimises the wasted stencil area.

The foil sheet that is attached is typical of foil stencil sheets known in the art. The foil is preferably attached by mechanical retention means or chemical means (such as adhesives) or a combination of the two. Preferably the attachment is by one or more of glue, rivets, crimping or soldering. Welding and brazing are also suitable, as would be the use of hocks or attachment points formed integrally with the frame. Gluing is especially preferred and, in particular, epoxy gluing is preferred. The use of epoxy glue allows for the production of an attractive looking framed sheet. The use of glue may be supplemented by the use of rivets to hold the foil in place while the glue sets.

The foil sheet is commonly made from metal sheets or foils. Preferably the sheet is made of aluminium, nickel or stainless steel sheets. It is preferred that the stencil-sheet has a thickness of from 0.025 mm to 2 mm, more preferably from 0.05 mm to 1 mm and most preferably from 0.075 mm to 0.5 mm. Techniques such as solder ball placement may favour stencils having thicker sheets in the range of from 0.05mm to 2 mm and more preferably 0.75 mm to 1 mm. The stencil will have holes cut in it by known techniques, such as laser cutting. The holes may be provided before or after the sheet is attached to the frame.

In one embodiment the foil does not extend into the corners. This helps to prevent the foil ripping if any extra tensioning is added. This is especially preferred in embodiments of the fourth aspect of the present invention, discussed below. It is preferred however that the foil extends to the corners since this minimises the preparation of the foil required before attachment.

It is preferred that the foil is attached under tension. This may be achieved by one of several techniques. These include, compressing the sides of the border member before attaching the foil. Thus, when the border member relaxes the foil is tensioned.

In one embodiment the border member may be provided with a slight outward curve during production so that when the foil is attached the border member is held in a straight sided position. Other techniques for pre-tensioning the foil include preheating the foil. This results in expansion of the foil which re-contracts on cooling after attachment and provides the desired tension.

According to a second aspect, the present invention provides for the use of the stencil printing frame described above in:
(a) printing at least a part of a solar cell;
(b) a method of wafer bumping and/or solder ball placement;
(c) applying solder to a substrate for surface mounting one or more electrical components;
(d) directly printing of one or more electrical components or circuits;
(e) printing at least a part of a fuel cell; or
(f) targeted deposition of any material onto a substrate.

Materials which can be printed to form parts of solar cells, electrical circuits or fuel cells are well known in the art. Fuel cells include, for example, polymer electrolyte membrane (PEM) cells, direct methanol fuel cells (DMFC) and solid oxide fuel cells (SOFC). Suitable materials for deposition may, therefore, include, for example, the polymer membranes, catalysts and any electrical connections. Electrical circuits include electrical connects and simple components which may be formed by printing, including, for example, wiring or dielectrophoretic coils. The stencil may be used to deposit the materials using any methods known in the art. Such methods include, for example, techniques similar to those described in relation to solder printing above, i.e. squeegee printing or direct printing methods.

Wafer bumping techniques and solder ball placement techniques using stencils are well known in the art. The stencil may optionally be spaced from the substrate (such as a PCB) by a thin flexible layer (such as resist) and flux and solder balls may be passed through the stencil, sequentially or simultaneously. The flexible layer protects the PCB and prevents smearing of pre-printed flux. Solder printing techniques are analogous and are well known in the art.

Other materials which may be printed or deposited include inks, dyes, glues and/or adhesives such as epoxy resins. These may be applied onto any suitable substrate including, for example, paper, a label, a canvas or a surface that is to be adhered to another.

A person skilled in the art would appreciate that the frames disclosed in the further aspects of the present invention could also be put to the above uses.

According to a third aspect, the present invention provides a method of manufacturing a stencil printing frame comprising:
i) providing a linear border member;
ii) machining the two ends of the linear border member to provide interlockable features which can be interlocked to form a joint;
iii) machining the linear border member to provide at least two bendable portions; and
iv) bending the bendable portions and interlocking the interlockable features to form the frame,
wherein each bendable portion is machined to comprise a segment having a reduced cross-section and two faces arranged to abut to prevent relative movement of the faces in the frame.

Each step in the method may be performed sequentially or simultaneously. It will be appreciated that the steps do not necessarily need to be carried out in order. For example, steps (ii) and (iii) could be carried out in a reversed order. Step (ii) could be carried out following step (iii) and concurrently with step (iv).

The method may further comprise attaching a foil sheet to the frame. In this way, the method of the present invention may be used to produce the stencil printing frame of the first aspect. It will be appreciated that any feature described in relation to the method, in particular features of the frame described therein, can be used equally in relation to the frame according to the other aspects of the present invention and vice versa. The foil sheet may have been etched or cut (including, for example, laser cut) so as to provide a stencil foil sheet. The foil sheet is preferably attached by one or more techniques including riveting, crimping, soldering, and gluing. Preferably the foil is attached under tension.

The step of providing the linear border member preferably comprises a step of extruding a strip of material, preferably aluminium. The linear border member is preferably extruded with a desired cross-section to minimise the necessary machining. The cross-section preferably provides a first flat region in the plane of the frame when formed. This flat region allows for the attachment of the foil sheet. The cross-section preferably includes a lip portion perpendicular to the plane of the frame. This lip portion allows for the engagement of the frame with a conventional frame-tensioning device.

It is preferred that the interlockable features and the bendable portions, including the abuttable faces, are formed by machining the linear border member. Machining includes cutting, grinding, stamping or other such techniques known in the art. For simplicity and reproducibility stamping is preferred.

According to a fourth aspect, the present invention provides a stencil printing frame comprising a border member and a foil sheet attached thereto, wherein the border member is formed as a single piece having sides and corners that define the frame, the single piece having two ends interlocked to form a joint on one corner or side, and wherein each corner comprises abutting faces arranged to allow expansion of the frame.

According to a fifth aspect, the present invention provides a stencil printing frame comprising a border member and a foil sheet attached thereto, wherein the border member is formed from two or more pieces together having sides and corners that define the frame, each piece having two ends each interlocked with an end of an adjacent piece to form a joint on one corner or side, and wherein at least one corner comprises abutting faces arranged to prevent relative movement of the faces.

It is preferred that at least one corner comprises a continuous strip joining two adjacent sides of the frame since this provides improved rigidity to the frame. While the frame can be formed from any number of interlocked pieces, it is preferred that the frame is formed from two pieces. In a preferred embodiment, the two pieces are identical for ease of production. In another embodiment the border member comprises a first piece that forms the majority of the frame, for example, three sides and four corners, or four sides and three corners, and a second piece forms the completing side or corner. Preferably at least one of the pieces is formed as a straight piece with a bendable portion so that it can be bent to form a corner of the frame. Most preferably, each piece comprises a bendable portion. By forming a multi- part frame, a more easily transported (non-constructed) frame may be obtained since it does not need to be as long as the sum total of the desired side lengths.

According to a further aspect of the present invention there is provided a border member for a stencil printing frame, formed as a single piece having bendable portions that can be bent to form corners of a frame, the single piece having two ends interlockable to form a joint on one corner or side of the frame, and wherein at least one bendable portion comprises abuttable faces arranged to prevent relative movement of the faces when the at least one bendable portion is bent to form a corner of the frame. Once bent, the border member is suitable for the attachment of a foil stencil sheet.

According to a further aspect of the present invention there is provided a border member for forming a stencil printing frame, formed as a single piece having bendable portions that can be bent to form corners of a frame for holding a foil sheet, the single piece having two ends interlockable to form a joint on one corner or side of the frame, and wherein at least one bendable portion comprises abuttable faces arranged to prevent relative movement of the faces when the at least one bendable portion is bent to form a corner of the frame.

According to a further aspect of the present invention there is provided a kit for forming a border member for a stencil printing frame, the kit comprising two or more pieces, at least one piece having a bendable portion that can be bent to form a corner of the border member (or frame), each piece having two ends interlockable to form a joint on one corner or side of the frame, and wherein at least one bendable portion comprises abuttable faces arranged to prevent relative movement of the faces when the at least one bendable portion is bent to form a corner of the frame.

According to a further aspect of the present invention there is provided a kit comprising the border member discussed above, in combination with a foil sheet. The foil sheet is suitable for use as a stencil printing sheet.

It should be appreciated that the features disclosed as preferable for the frame of the first aspect can be applied equally to the frames of the other aspects of the present invention.

The present invention will be described further with reference to the accompanying drawings provided by way of example, in which:

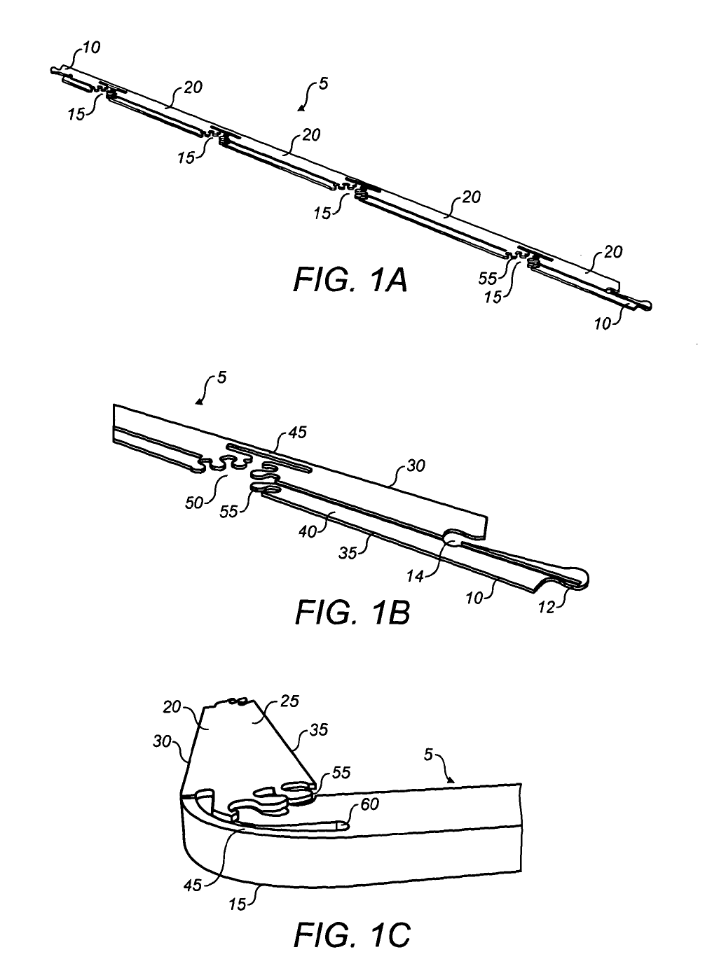

FIG. 1 shows an embodiment of a linear border member used in the method of the present invention. In particular, 2A shows the linear member, 2B shows a close-up of an interlockable end piece and 2C shows the interconnection of the pieces of a corner;

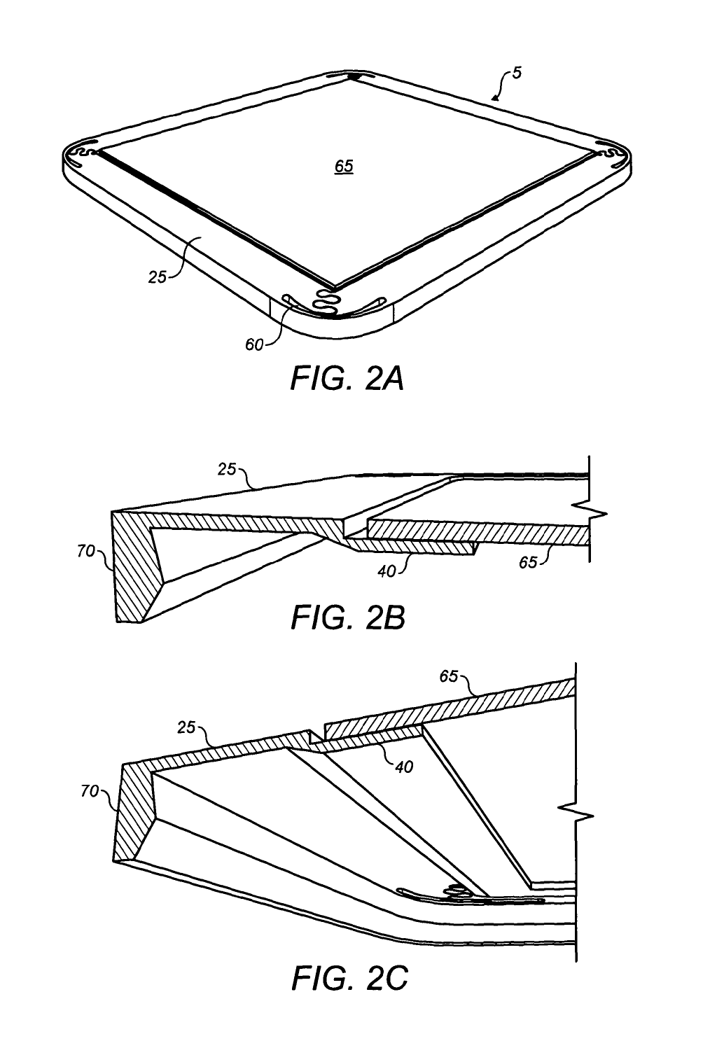

FIG. 2 shows an embodiment of the stencil printing frame according to the present invention. In particular, 3A shows a frame and foil sheet and 3B/3C show a cross-section of the frame highlighting a lip for bearing the foil sheet;

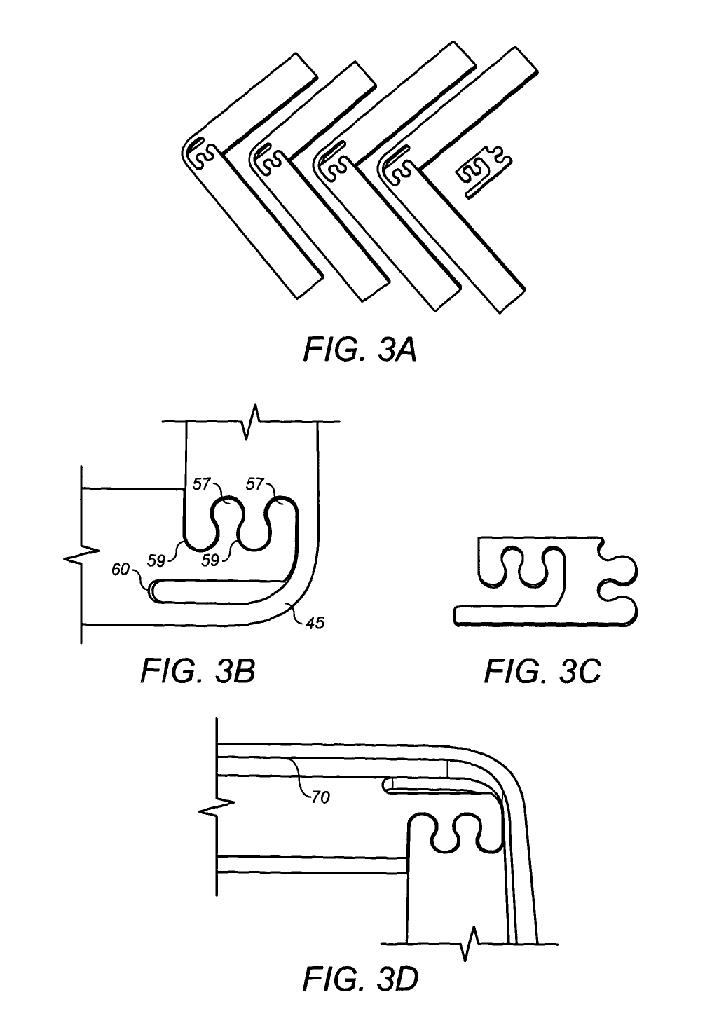

FIG. 3 shows embodiments of the corners of the border member of the frame of the present invention. In particular, 3B and 3D show top and bottom views of the same corner and FIG. 3C shows a stamped out section removed to form the bendable segment;

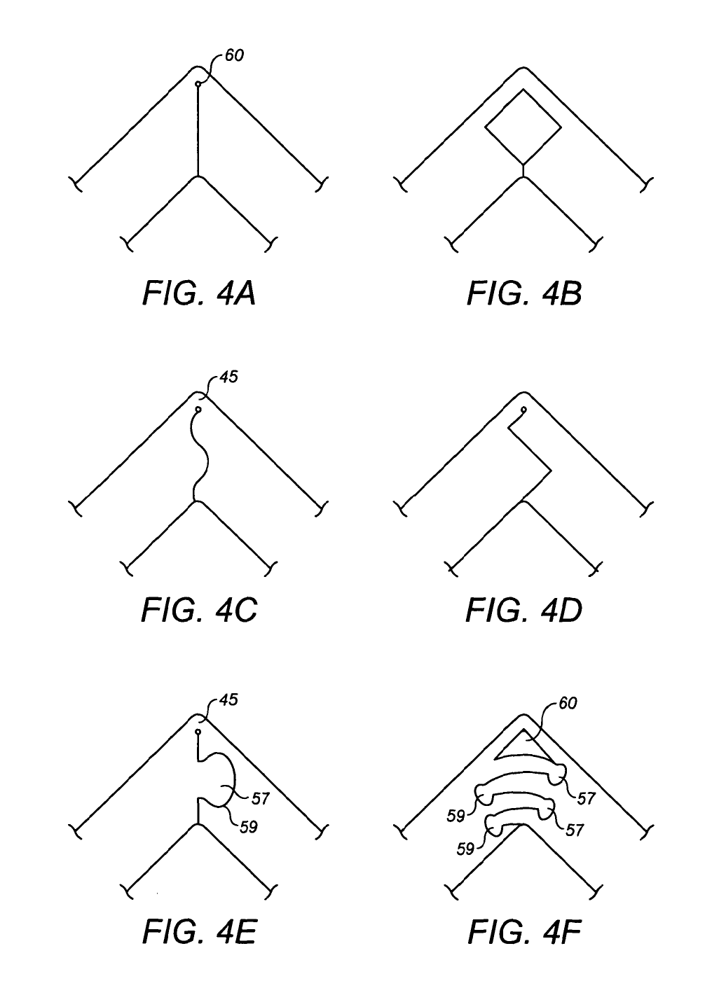

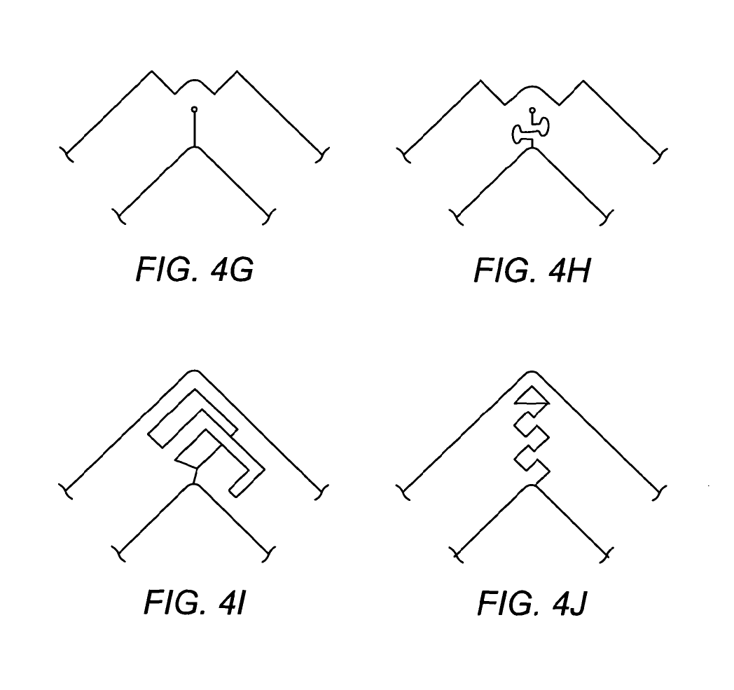

FIG. 4 shows further embodiments of the corners of the border member of the frame of the present invention;

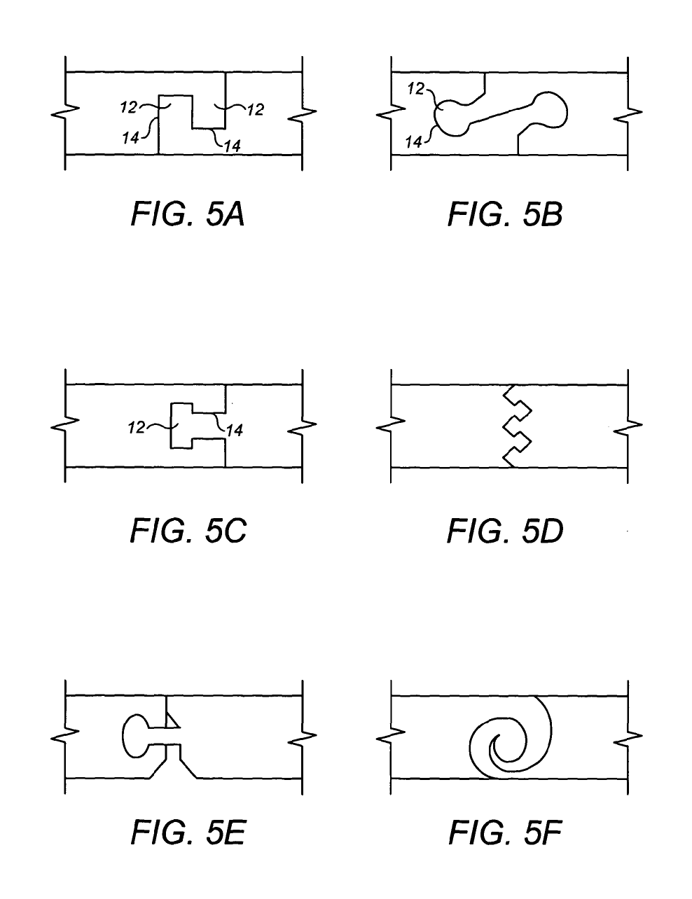

FIG. 5 shows embodiments of a joint in the side of a border member of the frame of the present invention;

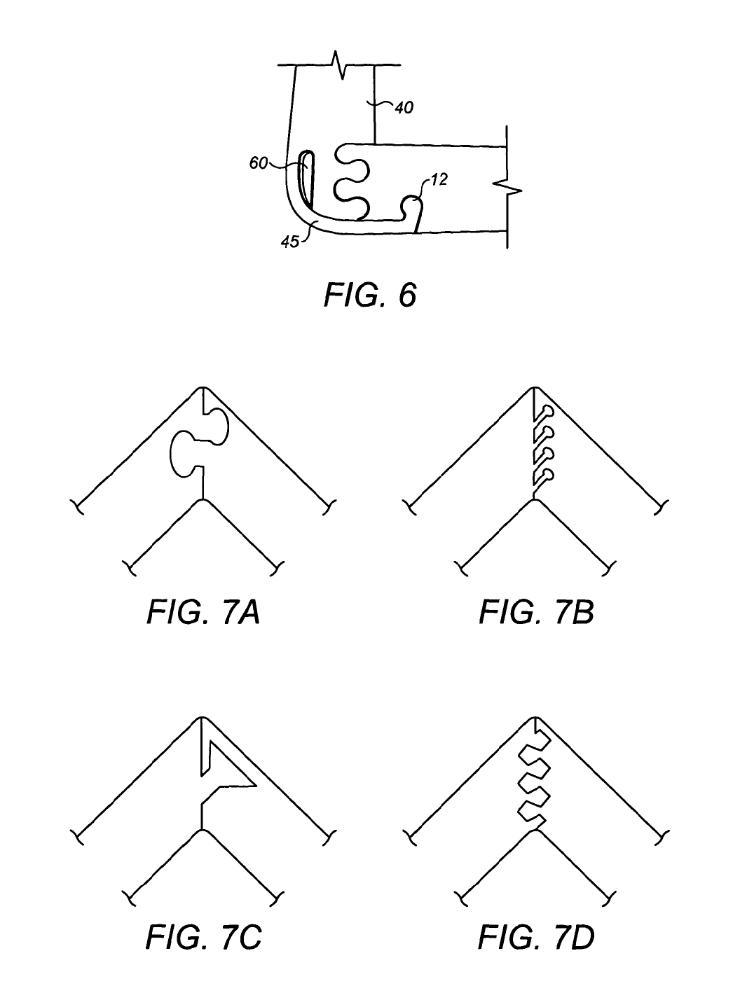

FIG. 6 shows an embodiments of a joint in the corner of the border member of the frame of the present invention;

FIG. 7 shows further embodiments of a joint in the corner of the border member of the frame of the present invention;

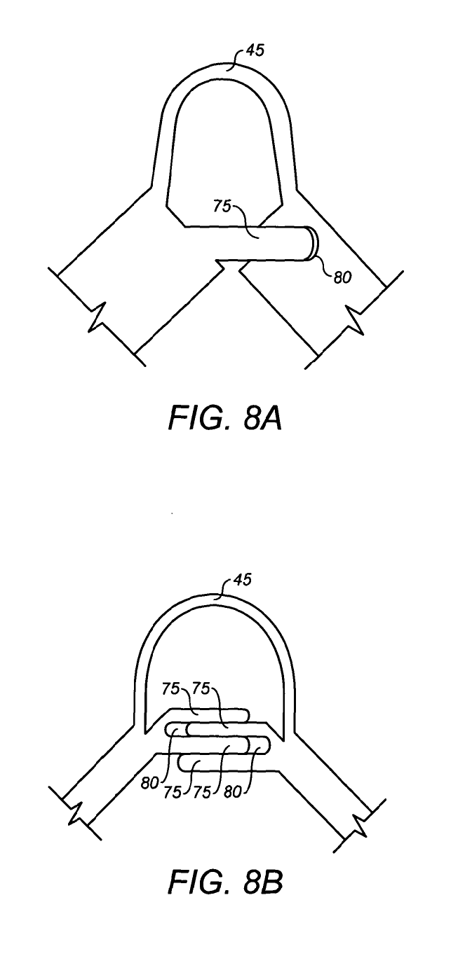

FIG. 8 shows two embodiments of the corners of the border member according to the fourth aspect of the present invention;

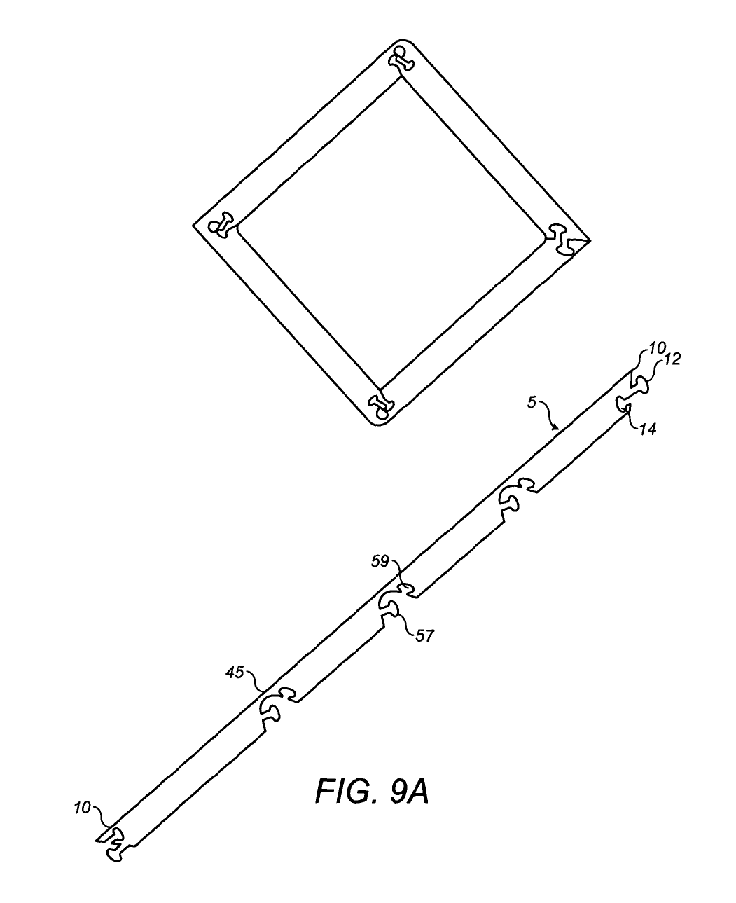

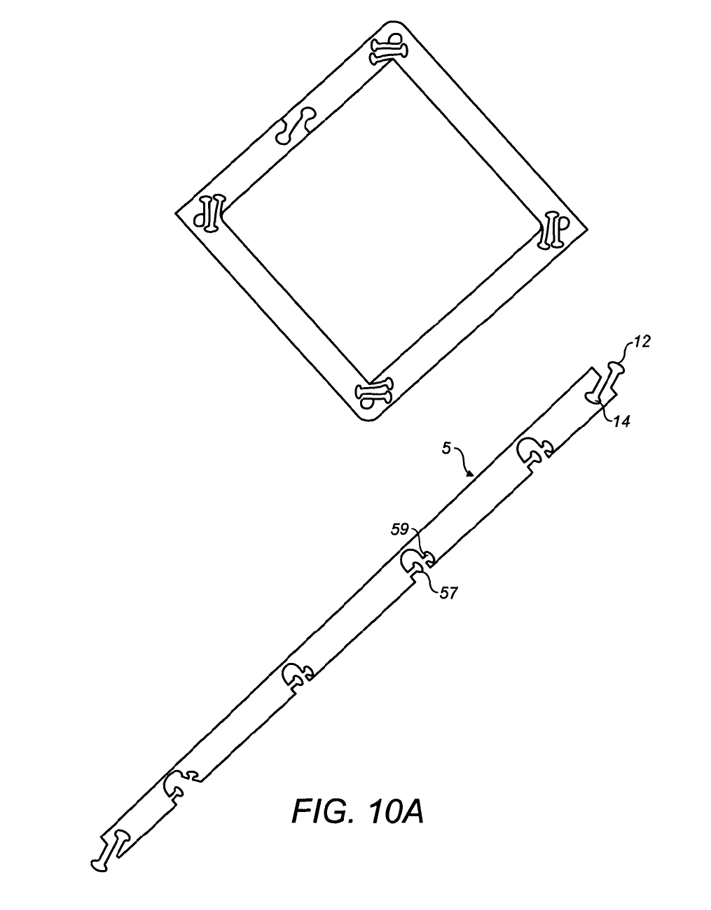

FIGS. 9A and 10A show two embodiments of the border member formed by the method of the present invention. In particular, 9A shows a border member with a corner joint and FIG. 10A shows a border member with a side joint;

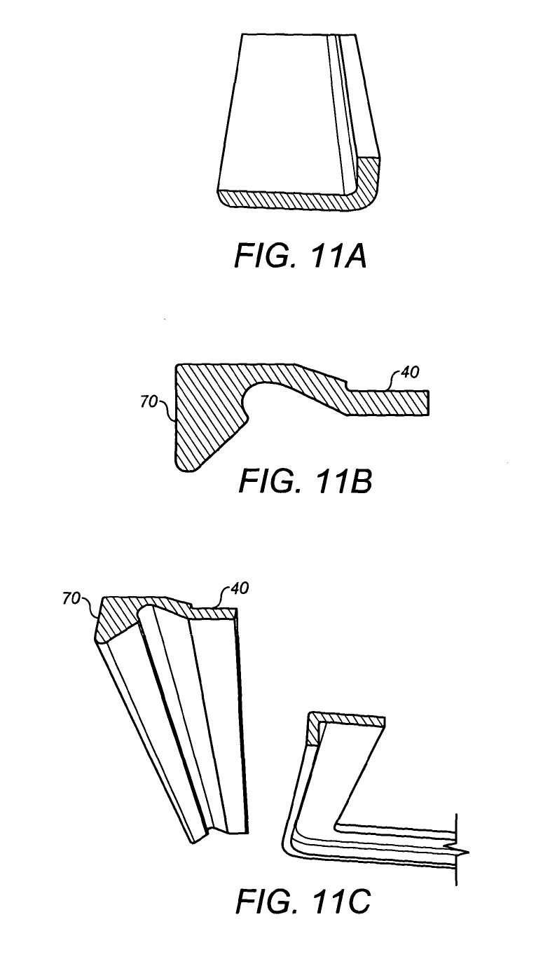

FIG. 11 shows embodiments of the cross-sectional profile of a border member of the frame of the present invention;

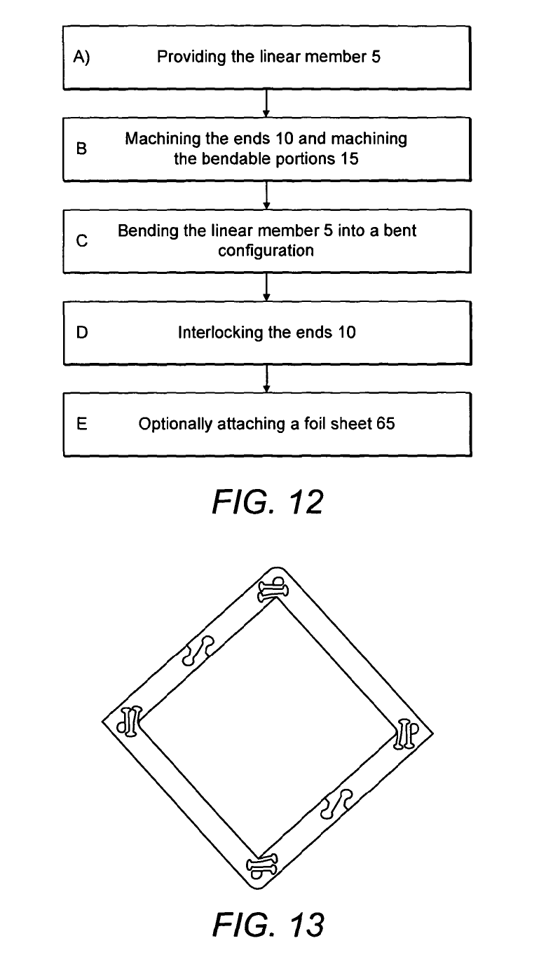

FIG. 12 shows a flowchart of the method steps of the present invention; and

FIG. 13 shows an embodiment of the fifth aspect of the present invention, where the border member is formed from two pieces.

While several of the embodiments in FIGS. 4, 5, 7, 8, 9 and 12 show features extending beyond the width of the side portions, a person skilled in the art would appreciate that for ease of stamping the features this is preferably not the case. While the exaggeration or simplification of features in the figures has been made to increase the clarity thereof, this does not preclude such embodiments from the scope of the claims.

The present invention will now be further described in relation to the figures. In the following passages different aspects/embodiments of the invention are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

FIG. 1A shows a linear member 5 for forming a frame. The linear member 5 has two ends 10 having interlockable features, and four bendable portions 15 interspaced by side portions 20. When the linear member 5 is bent into a frame a joint will be formed along one side by interlocking the two ends 10. The linear member 5 is preferably formed from a resilient material to allow repeated bending of the bendable portions 15 without significant damage to the linear member 5. The linear member 5 has an upper surface 25 having two sides; an outer side 30 having a continuous profile and an inner side 35. The upper surface 25 has a lip portion 40 extending from the inner side 35.

The ends 10 are shown in FIG. 1B. In this embodiment the ends 10 are each identical and have a complementary lobe 12 and socket 14. The lobe 12 is sized and arranged to fit snugly into the socket 14 such that when the linear member 5 is in a bent configuration the two ends 10 can be interlocked to form a single continuous side piece. For example, the lobe 12 may closely fit the socket 14 to form an interference fit.

A bendable portion 15 is shown in FIG. 1C. The bendable portion 15 is shown in the bent configuration, in contrast to the linear configuration shown in FIGS. 1A and 1B.

The bendable portion comprises a continuous strip 45 on the outer side 30 which has a narrower cross-section than that of the side portions 20. The strip 45 is continuous with the side portions 20, and joins two adjacent side portions 20 at a corner of the frame. Immediately adjacent to the strip 45 is an empty portion 50 which allows the strip 45 to bend. The empty portion 50 defines interconnectable features 55 and a linear slot 60. Linear slot 60 allows the strip 45 to deflect relative to the longitudinal direction defined by the adjacent side portions 20.

The interconnectable features 55 include alternate tabs 57 and blanks 59. The tabs 57 and blanks 59 on the surfaces of the bendable portion 15 are complementary so that they can be interconnected. As shown in FIG. 1C the interconnection may be performed by overlaying one side on the over and thus locating the tabs 57 in the blanks 59. As shown in FIG. 1C, a more rounded corner with lower stress in the strip 45 may be obtained by forming a longer and optionally wider linear slot 60.

FIG. 2A shows a linear member 5 in its bent configuration. Furthermore, a foil sheet 65 is attached to the lip portion 40 of the upper surface 25. In this figure the ends of the linear slot 60 can be seen.

FIGS. 2B and 2C show a cross-section of the frame of FIG. 2A. The foil sheet 65 is attached to the lip portion 40 by glue. The linear member 5 has a retaining portion 70 extending perpendicular from the plan of the foil sheet 65 and extending along the linear member 5. This allows for the retention of the frame in a frame tensioning apparatus. The retaining portion 70 has a bevelled surface on the inner side face of the linear member 5; this further helps to retain the frame in a frame tensioning apparatus.

FIG. 3A shows bendable portions 15 in the bent configuration. Each configuration has been formed with different interconnectable features 55 and a different length of linear slot 60. FIG. 3B shows a close-up of the upper surface 25. FIG. 3D shows a close-up of the lower surface having a retaining portion 70. FIG. 3C shows a stamped portion removed from a linear member 5 to form the empty portion 50.

FIG. 4 shows a number of arrangements of the bendable portion 15 in the bent configuration. It should be appreciated that the linear slot 60, which has been minimised for clarity in these figures, will vary in length significantly, depending on the selection of the material the strength of the frame that is required.

FIG. 4A shows a bendable portion without interconnectable features 55. Rather the bendable portion 15 on the inner side has faces formed as straight surfaces which simply abut. The abutting faces prevent relative movement of the side portions in a rotational sense and in the direction perpendicular to the straight surfaces. FIG. 4B shows a similar configuration with a longer linear slot 60. In these two examples, slippage of the linear member 5 along the abutting straight edges can cause sheer stress in the strip 45.

FIG. 4C shows a wavy arrangement of the faces. While the faces do not interconnect they are complementary. The nonlinear arrangement can prevent relative movement of the faces, not only in the rotational and perpendicular sense (as in FIGS. 4A and 4B), but also can prevent relative movement in the sense of slippage of one face relative to the other. The nonlinear arrangement thereby serves to reduce the stress exerted on the strip 45. FIG. 4D shows a similar configuration. The straight edges are preferred for ease of machining or stamping.

FIG. 4E shows a configuration having an interconnected tab 57 and blank 59. FIG. 4F shows a configuration with a plurality of tabs 57 and blanks 59 interconnected.

FIGS. 4G and 4H demonstrate that the strip 45 does not necessarily need to be in line with the outer edge of the side portions 20 of the linear member 5. FIGS. 4I and 4J show further embodiments. The straight edges of these embodiments allow for simpler machining.

As can be seen in FIGS. 9A and 10A, a frame can be formed from a single linear member 5 in two ways. Firstly, as shown in FIG. 9A, the linear member 5 may be arranged such that the interlocking ends 10 come together to form a corner joint. Alternatively, as shown in FIG. 10A, the linear member 5 may be arranged such that the interlocking ends 10 come together to form a joint located along one side of the frame. The joint would preferably, but not necessarily, be located at the mid-point of one side of the frame.

FIGS. 5A to 5F show configurations of joints in the side portions 20. The joints all comprise different shaped and sized lobes 12 and sockets 14 which are interlocked. Embodiments such as 5A and 5B are especially preferred since they can be formed as identical ends 10 and interlock with themselves. This simplifies the stamping procedure since the ends are identically formed.

FIG. 6 shows a corner joint configuration. Note how the arrangement mirrors the interconnectable features 55 that can be used in the other corners (FIG. 1C). In this embodiment the joint comprises a long lobe 12 which extends around the corner into a socket on the side portion 20. FIG. 7A-7D show embodiments with one or more interlockable lobes 12 and sockets 14.

FIGS. 8A and 8B show an embodiment of the third aspect of the present invention. As will be appreciated, the linear member 5 is provided with a long strip 45 which is bent into a loop to allow the interconnection of one or more shafts 75 and corresponding channels 80. Since the strip 45 is bendable, if the side portions 20 are pulled so as to expand the frame then the one or more shafts 75 will slide within the channels 80 to allow the frame to expand. Preferably such a frame would have a matching pair or pairs of these corners so that the frame can be expanded evenly in a tensioning frame.

With reference to FIG. 12, the method of the present invention will now be discussed. The linear member 5 is first provided (step A). Preferably the linear member 5 is manufactured by extrusion which forms the upper surface 20, the retaining portion 70, and the lip portion 40. FIG. 11 shows examples of linear member 5 having suitable cross-sections that may be formed by extrusion. In step B the ends 10 and the bendable portions 15 are machined to provide the interlockable and interconnectable features respectively.

In step C the linear member 5 is bent into the bent configuration. In step D the features are interconnected and interlocked respectively. These steps are preferably performed by hand and in a stepwise manner such that each bendable portion 15 is bent in turn and finally the interlockable features are interlocked. This forms the completed frame.

In an optional step E a foil sheet is attached to the upper surface 20 of the frame.

The present invention will now be described in relation to the following non-limiting example.

### EXAMPLE

Three foil stencils were prepared using metal sheets of the same thickness. The first sheet was a standard Tetra™ foil sheet (see FIG. 1A) having a plurality of holes that allow it to be held in a Tetra™ frame tensioning device. A stencil frame as described in US2008/0216681 was prepared having an untensioned segmented expandable frame with a foil sheet attached thereto. Such a frame, which is coded VG herein is inserted into a frame tensioning device before use which expands the frame and tensions the foil. Lastly a pre-tensioned frame according to the present invention was prepared.

The framed foil sheets of the comparative examples were placed in their proprietary frame tensioning devices and the tension in the foil sheet was measured using a conventional measurement device. The stencil printing frame of the present invention was then tested in each of the proprietary frame tensioning devices. Advantageously, the frame of the present invention is pre-tensioned, although beneficially it is compatible with conventional frame tensioning devices which can be used to increase the tension and to register the stencil over a printing substrate.

TABLE 1
Tension Summary Table

| | Centre | Edge |
|---|---|---|
| Tetra ™ foil/Tetra ™ Frame | 32 N | 30 N |
| Invention foil + frame/Tetra ™ Frame | 36 N | 32 N |
| Invention foil + frame/VG Frame | 38 N | 36 N |
| VG foil/VG Frame | 38 N | 36 N |

As can be seen from the table, because of the build in pre-tension the foil of the present invention, using the frame in a Tetra™ frame gives a higher total tension of 36N compared to 32N for the Tetra foil. The results also show that a comparable tension is obtained when using the VG frame-tensioning device as is obtained when using the frame designed for use with that device.

Embodiments of the present invention can provide a stencil printing frame with a number of key benefits:
1. Lower production costs/cheaper to make.
2. Improved handling and user safety by elimination of all sharp edges.
3. Improved functionality due to pre-tension of the stencil in the flat sub-frame which results in less printing defects/higher production yields.
4. Less stencil damage due to the rigid aluminium sub-frame resulting in longer stencil lifetime. The frame has a greater rigidity than frames such as VG.
5. Better storage due to the fact that the stencil is mounted in a flat fixed sub-frame which makes it a lot easier to store compared to an “unsupported” foil.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1-20. (canceled)

21. A stencil printing frame, comprising:
a border member; and
a foil sheet attached thereto,
wherein the border member is formed as a single piece having sides and corners that define the frame, the single piece having two ends interlocked to form a joint on one corner or side, and wherein at least one corner comprises abutting faces arranged to prevent relative movement of the faces.

22. A stencil printing frame according to claim 21, wherein each corner comprises abutting faces arranged to prevent relative movement of the faces.

23. A stencil printing frame according to claim 21, wherein the abutting faces have non-planar complementary profiles.

24. A stencil printing frame according to claim 21, wherein the abutting faces have interconnecting profiles.

25. A stencil printing frame according to claim 21, wherein the border member is formed of aluminium or an alloy thereof.

26. A stencil printing frame according to claim 21, wherein the border member forms a rectangle.

27. A stencil printing frame according to claim 21, wherein the foil sheet is attached by one or more of glue, rivets, crimping and/or soldering.

28. A stencil printing frame according to claim 21, wherein the foil is attached to the border member under tension.

29. A method of manufacturing a stencil printing frame comprising:
providing a linear border member;
machining the two ends of the linear border member to provide interlockable features which can be interlocked to form a joint;
machining the linear border member to provide at least two bendable portions; and
bending the bendable portions and interlocking the interlockable features to form the frame,
wherein each bendable portion is machined to comprise a segment having a reduced cross-section and two faces arranged to abut to prevent relative movement of the faces in the frame.

30. A method according to claim 29, wherein the method further comprises attaching a foil sheet to the frame.

31. A method according to claim 30, wherein the foil is attached by one or more techniques including riveting, crimping, soldering, and/or gluing.

32. A method according to claim 30, wherein the foil is attached under tension.

33. A method according to claim 29, wherein at least one of the following is true:
the linear border member is extruded; and
the interlockable features and/or the bendable portions are formed by cutting, grinding and/or stamping.

34. A border member for forming a stencil printing frame, formed as a single piece having bendable portions that can be bent to form corners of a frame for holding a foil sheet, the single piece having two ends interlockable to form a joint on one corner or side of the frame, and wherein at least one bendable portion comprises abuttable faces arranged to prevent relative movement of the faces when the at least one bendable portion is bent to form a corner of the frame.
